(19) United States
(12) Patent Application Publication
(10) Pub. No.: US 2026/0110889 A1
(43) Pub. Date: Apr. 23, 2026

(54) MULTI-CHANNEL OPTICAL INTERFERENCE MICROSCOPIC SYSTEM

(71) Applicant: Industrial Technology Research Institute, Hsinchu (TW)

(72) Inventors: Jhe-Ruei Li, Tainan City (TW); Chung-Li Tai, Tainan City (TW); Chien-Chun Kuo, Tainan City (TW); Kai-Shiang Gan, Tainan City (TW)

(73) Assignee: Industrial Technology Research Institute, Hsinchu (TW)

(21) Appl. No.: 18/981,615

(22) Filed: Dec. 15, 2024

(30) Foreign Application Priority Data
Oct. 17, 2024 (TW) 113139474

(51) Int. Cl. G02B 21/00; G02B 21/02

(52) U.S. Cl. CPC G02B 21/0056; G02B 21/0032; G02B 21/02

(57) ABSTRACT

A multi-channel optical interference microscopic system includes at least one light source, an objective lens array device, multiple waveguides, and multiple sensors. The objective lens array device includes multiple objective lenses arranged in an array. The waveguides respectively correspond to the objective lenses. The sensors respectively correspond to the waveguides. The sensors include at least a first sensor and a second sensor. At least two of the waveguides respectively transmit light to be measured in a first direction and a second direction, and the first direction is different from the second direction. The light to be measured transmitted in the first direction enters the first sensor, and the light to be measured transmitted in the second direction enters the second sensor.

### CROSS-REFERENCE TO RELATED APPLICATION

This application claims the priority benefit of Taiwan application serial no. 113139474, filed on Oct. 17, 2024. The entirety of the above-mentioned patent application is hereby incorporated by reference herein and made a part of this specification.

### TECHNICAL FIELD

The disclosure relates to an optical interference microscopic system, and particularly relates to a multi-channel optical interference microscopic system.

### BACKGROUND

In the conventional technology, an optical interference microscope system is formed by a light source module, an objective lens array device, and a single sensor 1, in which the objective lens array device includes multiple objective lenses. Due to the limited field of view (FOV) of the single sensor and the crosstalk from light coming from different objective lenses, the measurement accuracy and efficiency of the system are reduced.

### SUMMARY

The disclosure provides a multi-channel optical interference microscopic system with a large field of view and high measurement accuracy.

According to an embodiment of the disclosure, a multi-channel optical interference microscopic system is provided, which is adapted to measure an object to be measured. The multi-channel optical interference microscopic system includes at least one light source, an objective lens array device, multiple waveguides, and multiple sensors. The light source is configured to emit illumination light. The illumination light is configured to illuminate the object to be measured and is reflected by the object to be measured into a light to be measured. The objective lens array device includes multiple objective lenses. The waveguides receive the light to be measured through the objective lens array device. The sensors include at least a first sensor and a second sensor. The waveguides include at least one first waveguide transmitting the light to be measured in a first direction and at least one second waveguide transmitting the light to be measured in a second direction, and the first direction is different from the second direction. The light to be measured outputted from the first waveguide enters the first sensor, and the light to be measured outputted from the second waveguide enters the second sensor.

Based on the above, the multi-channel optical interference microscopic system provided by the embodiments of the disclosure is configured with the multiple waveguides corresponding to the multiple objective lenses, and different waveguides correspond to different objective lenses. Therefore, the light coming from different objective lenses may enter different waveguides without the crosstalk. In addition, since the light outlets of the different waveguides are spaced apart from each other, different sensors may be disposed outside the respective light outlets. Therefore, the phenomenon of insufficient field of view can be avoided, and the measurement accuracy of the system can be greatly increased.

Several exemplary embodiments accompanied with figures are described in detail below to further describe the disclosure in details.

### BRIEF DESCRIPTION OF THE DRAWINGS

FIG. 1A shows a cross-sectional schematic diagram of a multi-channel optical interference microscopic system according to an embodiment of the disclosure.

FIG. 1B shows a schematic diagram of a waveguide in FIG. 1A.

FIG. 1C shows a schematic diagram of an objective lens and an object to be measured in FIG. 1A.

FIG. 2 shows a schematic configuration diagram of some components of the multi-channel optical interference microscopic system according to an embodiment of the disclosure.

FIG. 3 shows a schematic configuration diagram of some components of the multi-channel optical interference microscopic system according to an embodiment of the disclosure.

FIG. 4 shows a schematic configuration diagram of some components of the multi-channel optical interference microscopic system according to an embodiment of the disclosure.

FIG. 5 shows a schematic diagram of a multi-channel optical interference microscopic system according to an embodiment of the disclosure.

### DETAILED DESCRIPTION

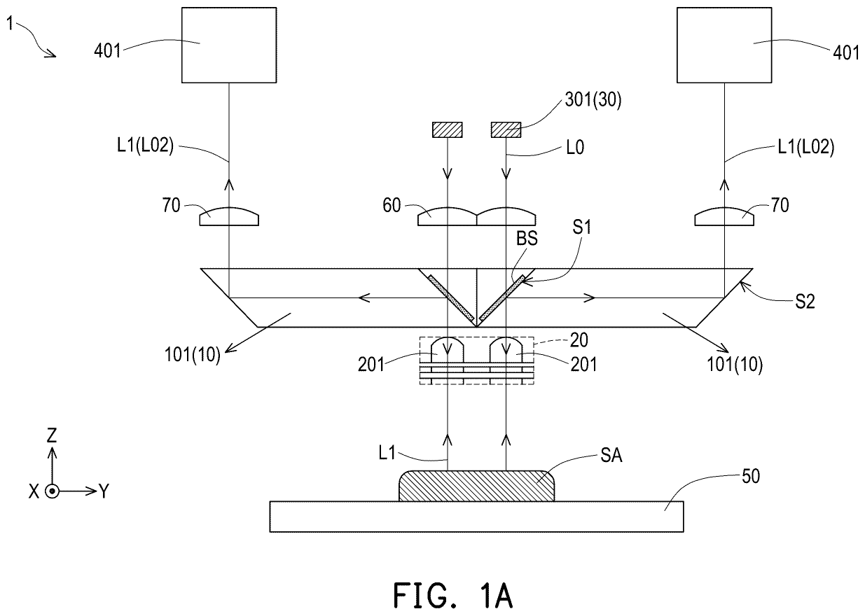

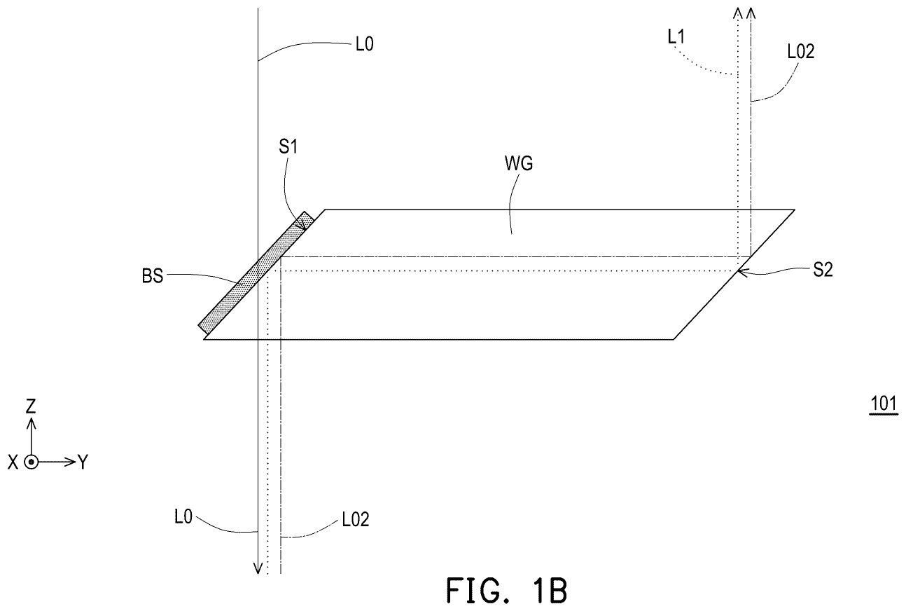

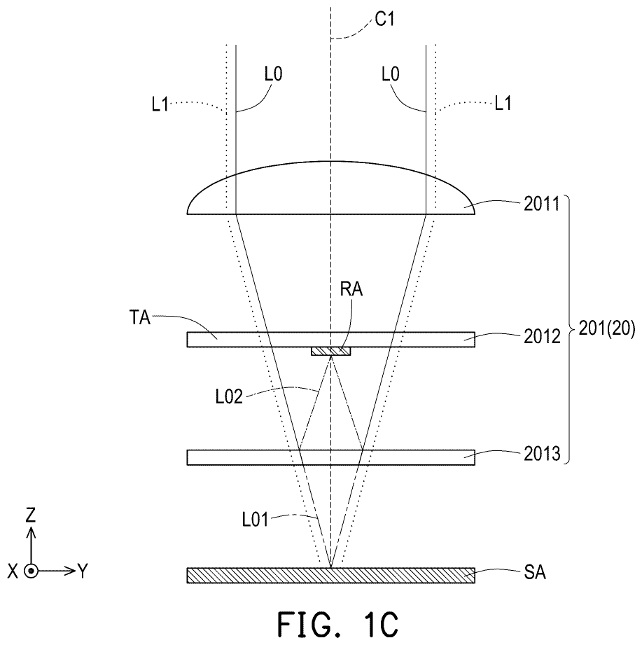

Referring to FIG. 1A, FIG. 1B, and FIG. 1C, FIG. 1A shows a cross-sectional schematic diagram of a multi-channel optical interference microscopic system 1 according to an embodiment of the disclosure, FIG. 1B shows a schematic diagram of a waveguide 101 in FIG. 1A, and FIG. 1C shows a schematic diagram of an objective lens 201 and an object to be measured SA in FIG. 1A. The multi-channel optical interference microscopic system 1 provided by an embodiment of the disclosure may, for example, be implemented as a nanoscale optical detection system for detecting the three-dimensional structure of the object to be measured SA, but the disclosure is not limited thereto.

As shown in FIG. 1A, the multi-channel optical interference microscopic system 1 includes a light source module 30, an objective lens array device 20, a waveguide module 10, multiple sensors 401, an image processing unit (not shown) connected to the sensors 401, multiple focus lens elements 60, and multiple collimating lens elements 70. The light source module 30 may include one or more light sources 301. The waveguide module 10 includes a plurality of waveguides 101, and the objective lens array device 20 includes a plurality of objective lenses 201 respectively corresponding to the waveguides 101, in which the objective lenses 201 may be arranged in an array form.

In an embodiment, the image processing unit is, for example, a central processing unit (CPU), a microprocessor, a digital signal processor (DSP), a programmable controller, a programmable logic device (PLD), or other similar devices or combinations of the devices, and the disclosure is not limited thereto. In addition, in an embodiment, each function of the image processing unit may be implemented as a plurality of program codes. The program codes are stored in a memory, and the program codes are executed by the image processing unit. Alternatively, in an embodiment, each function of the image processing unit may be implemented as one or more circuits. The disclosure does not limit the implementation of each function of the image processing unit to either software or hardware.

The light source 301 is configured to emit illumination light L0, and the illumination light L0 is used to illuminate an object to be measured SA. The sensors 401 are respectively disposed outside the light exit surfaces (that is, light outlets) of the waveguides 101 for sensing the light from the waveguides 101. It should be noted that, as shown in FIG. 1A, the multi-channel optical interference microscopic system 1 may include at least two waveguides 101 transmitting light in different directions respectively.

The multi-channel optical interference microscopic system 1 provided in the embodiment is configured with multiple waveguides 101 corresponding to multiple objective lenses 201, and different waveguides 101 correspond to different objective lenses 201. Therefore, light from different objective lenses 201 may enter different waveguides 101 without the crosstalk. In addition, since the light outlets of different waveguides 101 are spaced apart from each other, different sensors 401 may be disposed outside the respective light outlets. Therefore, multiple sensors can be adapted to expand the field of view together, and the measurement accuracy of the system can be greatly increased.

Further, referring to FIG. 1A together with FIG. 1B, each waveguide 101 includes a light guide part WG and a beam splitter BS. The light guide part WG has a first optical surface S1 and a second optical surface S2. The beam splitter BS is disposed on the first optical surface S1. The beam splitter BS allows at least part of the illumination light L0 to penetrate, in which the illumination light L0 penetrating the beam splitter BS may illuminate the object to be measured SA.

Next, referring to FIG. 1A together with FIG. 1C, each objective lens 201 has an optical axis C1 and includes a lens 2011, a patterned optical element 2012, and a beam splitting element 2013 sequentially stacked along the optical axis C1. The patterned optical element 2012 includes a transmission area TA and a reflection area RA. The illumination light L0 traveling toward the object to be measured SA includes first portion illumination light L01 and second portion illumination light L02, in which the first portion illumination light L01 sequentially penetrates the lens 2011, the transmission area TA of the patterned optical element 2012, and the beam splitting element 2013, and then illuminates the object to be measured SA.

Referring to FIG. 1A, FIG. 1B, and FIG. 1C simultaneously, as shown in FIG. 1C, the second portion illumination light L02 sequentially penetrates the lens 2011 and the transmission area TA of the patterned optical element 2012 and is reflected by the beam splitting element 2013. After being reflected by the reflection area RA of the patterned optical element 2012, the second portion illumination light L02 is reflected again by the beam splitting element 2013, and sequentially penetrates the transmission area TA of the patterned optical element 2012 and the lens 2011, and then enters the waveguide 101 shown in FIG. 1B. As shown in FIG. 1B, the beam splitter BS disposed on the first optical surface S1 of the waveguide 101 reflects the second portion illumination light L02, which allows the second portion illumination light L02 to travel along the light guide part WG, leave the waveguide 101 from the light outlet of the waveguide 101, and enter the corresponding sensor 401.

On the other hand, as shown in FIG. 1C, the object to be measured SA reflects and/or scatters the first portion illumination light L01 to generate a light to be measured L1. After sequentially penetrating the beam splitting element 2013, the transmission area TA of the patterned optical element 2012, and the lens 2011, the light to be measured L1 enters the waveguide 101 shown in FIG. 1B. As shown in FIG. 1B, the beam splitter BS disposed on the first optical surface S1 of the waveguide 101 reflects the light to be measured L1, which allows the light to be measured L1 to travel along the light guide part WG, leave the waveguide 101 from the light outlet of the waveguide 101, and enter the corresponding sensor 401.

As mentioned above, the sensor 401 may receive the light to be measured L1 and the second portion illumination light L02 at the same time, and thus generate an interference image. It should be noted that the light to be measured L1 and the second portion illumination light L02 are parallel lights in the light guide part WG. Therefore, the interference image does not change as the sensor 401 is at different positions.

In this embodiment, as shown in FIG. 1A and FIG. 1B, the second optical surface S2 may reflect the light to be measured L1 and the second portion illumination light L02 to divert the light to be measured L1 and the second portion illumination light L02. In other words, the embodiment uses multiple waveguides 101 to provide a higher design margin. In some embodiments, each waveguide 101 may be an etched surface waveguide that utilizes diffraction effects to guide light, couple light out, and couple light in.

The multi-channel optical interference microscopic system 1 may further include a moving mechanism (not shown), and the moving mechanism may move a substrate 50 on which the object to be measured SA is placed along a direction parallel to the optical axis C1 of the objective lens 201. When the distance between the object to be measured SA and the light source module 30 changes, the interference image generated by the light to be measured L1 and the second portion illumination light L02 changes. Accordingly, the image processing unit connected to the sensor 401 may obtain the three-dimensional structure of the object to be measured SA to complete the detection.

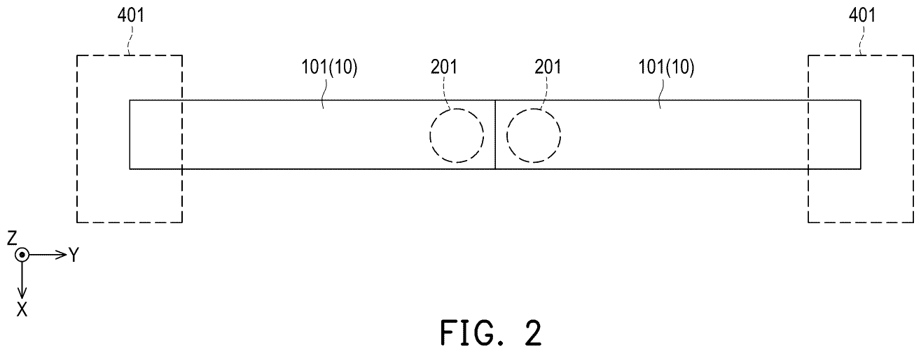

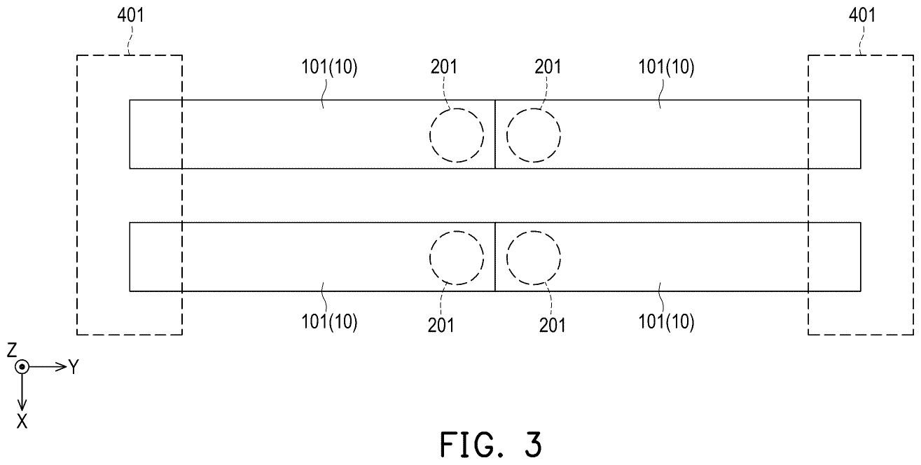

Referring to FIG. 1A and FIG. 2 simultaneously, FIG. 2 shows a schematic configuration diagram of some components of the multi-channel optical interference microscopic system 1 according to an embodiment of the disclosure. In the embodiment of the disclosure, when viewed from above at the multi-channel optical interference microscopic system 1 in a −Z direction in FIG. 1A, the multi-channel optical interference microscopic system 1 includes a waveguide 101 that transmits light in a +Y direction, a waveguide 101 that transmits light in a −Y direction, two objective lenses 201 corresponding to the two waveguides 101, and two sensors 401 corresponding to the two waveguides 101. Referring to FIG. 1A and FIG. 3 simultaneously, FIG. 3 shows a schematic configuration diagram of some components of the multi-channel optical interference microscopic system 1 according to an embodiment of the disclosure. In the embodiment of the disclosure, when viewed from above at the multi-channel optical interference microscopic system 1 in a −Z direction in FIG. 1A, the multi-channel optical interference microscopic system 1 includes two waveguides 101 that transmit light in the +Y direction, two waveguides 101 that transmit light in the −Y direction, four objective lenses 201 corresponding to the four waveguides 101, a sensor 401 corresponding to the two waveguides 101 that transmit light in the +Y direction, and a sensor 401 corresponding to the two waveguides 101 that transmit light in the −Y direction.

In some embodiments, the multi-channel optical interference microscopic system 1 may include N1 waveguides 101 that transmit light in the +Y direction, N2 waveguides 101 that transmit light in the −Y direction, (N1+N2) objective lenses corresponding to the (N1+N2) waveguides 101, a sensor 401 corresponding to the N1 waveguides 101 that transmit light in the +Y direction, and a sensor 401 corresponding to the N2 waveguides 101 that transmit light in the −Y direction, in which N1 and N2 are positive integers greater than or equal to 1, and N1 may be equal to N2 or not equal to N2.

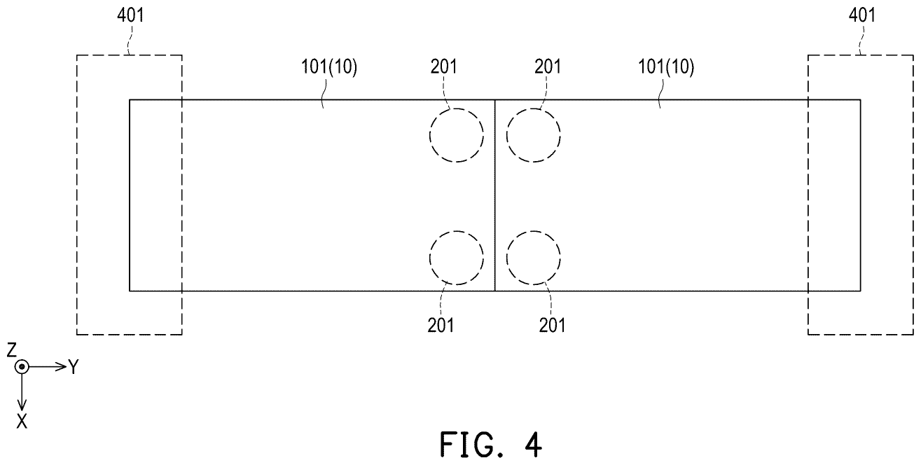

In the embodiments shown in FIG. 2 and FIG. 3, the quantity of the objective lenses 201 in the multi-channel optical interference microscopic system 1 is equal to the quantity of the waveguides 101, but the disclosure is not limited thereto. Specifically, referring to FIG. 1A and FIG. 4, FIG. 4 shows a schematic configuration diagram of some components of the multi-channel optical interference microscopic system 1 according to an embodiment of the disclosure. In this embodiment, when viewed from above at the multi-channel optical interference microscopic system 1 in the −Z direction in FIG. 1A, the multi-channel optical interference microscopic system 1 includes a waveguide 101 that transmits light in the +Y direction, a waveguide 101 that transmits light in the −Y direction, two objective lenses 201 corresponding to the waveguide 101 that transmits light in the +Y direction (the waveguide 101 may receive the light to be measured passed through the two objective lenses 201), two objective lenses 201 corresponding to the waveguide 101 that transmits light in the −Y direction (the waveguide 101 may receive the light to be measured passed through the two objective lenses 201), a sensor 401 corresponding to the waveguide 101 that transmits light in the +Y direction, and a sensor 401 corresponding to the waveguide 101 that transmits light in the −Y direction. In the embodiment shown in FIG. 4, the quantity of the objective lenses 201 in the multi-channel optical interference microscopic system 1 is greater than the quantity of the waveguides 101.

In order to fully illustrate various implementation manners of the disclosure, other embodiments of the disclosure will be described below. It should be noted here that the following embodiments follow the reference signs and part of the content of the previous embodiments, in which the same reference signs are used to represent the same or similar elements, and descriptions of the same technical content are omitted. For descriptions of omitted parts, reference may be made to the foregoing embodiments and will not be repeated in the following embodiments.

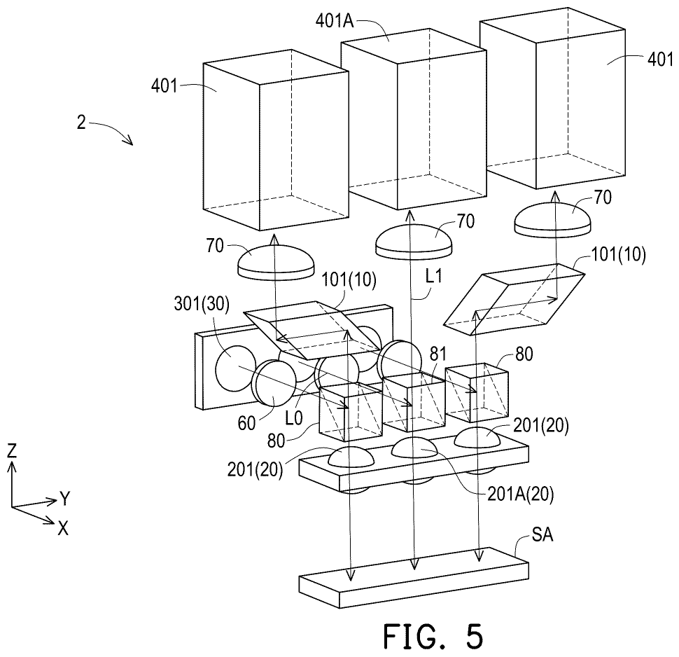

Referring to FIG. 5, FIG. 5 shows a schematic diagram of a multi-channel optical interference microscopic system 2 according to an embodiment of the disclosure.

As shown in FIG. 5, the multi-channel optical interference microscopic system 2 includes the light source module 30, the objective lens array device 20, the waveguide module 10, the multiple sensors 401, at least one center sensor 401A, multiple beam splitters 80, at least one center beam splitter 81, an image processing unit (not shown) connected to the center sensor 401A and the sensors 401, the multiple focus lens elements 60, and the multiple collimating lens elements 70. The light source module 30 includes a plurality of light sources 301. The waveguide module 10 includes a plurality of waveguides 101, and the objective lens array device 20 includes at least one center objective lens 201A, and a plurality of objective lenses 201 corresponding to the waveguides 101 respectively.

The cooperative relationship between the two light sources 301, the two focus lens elements 60, the two objective lenses 201, the two waveguides 101 (transmitting light along the +Y direction and the −Y direction respectively), the two collimating lens elements 70, and the two sensors 401 as shown in FIG. 5 is the same as the multi-channel optical interference microscopic system 1 shown in FIG. 1A, so details will not be repeated here.

The difference between the multi-channel optical interference microscopic system 2 shown in the embodiment and the multi-channel optical interference microscopic system 1 shown in FIG. 1A is that the multi-channel optical interference microscopic system 2 further utilizes the multiple beam splitters 80 and the at least one center beam splitter 81 to transmit the illumination light L0. The illumination light L0 from the light sources 301 is reflected by the beam splitters 80 and the at least one center beam splitter 81 respectively, and then illuminates the object to be measured SA. In the embodiment, the illumination light L0 reflected by the center beam splitter 81 is formed into the light to be measured L1 after being reflected or scattered by the object to be measured SA. The light to be measured L1 penetrates the center objective lens 201A and the center beam splitter 81, and then enters the center sensor 401A, without needing to be transmitted through the waveguides 101. In this embodiment, there is one center objective lens 201A. In other implementation manners, the quantity of the center objective lenses may also be multiple. The light to be measured L1 passed through the center objective lenses enters the same center sensor in parallel, or enters several center sensors individually.

However, the disclosure is not limited thereto. In an embodiment not shown, the multi-channel optical interference microscopic system 2 further includes another waveguide (the third waveguide) disposed above the center beam splitter 81, and the center sensor 401A and the collimating lens element 70 corresponding to the center sensor 401A are disposed above the light exit surface (that is, the light outlet) of the waveguide. The waveguide has the same structure as the waveguide 101 and is positioned to transmit light along a +X direction (the third direction). After penetrating the center objective lens 201A and the center beam splitter 81, the light to be measured L1 travels along a +Z direction and enters the waveguide. After being reflected by the beam splitter BS on the first optical surface S1 of the waveguide, the light to be measured L1 travels along the +X direction in the waveguide, is reflected by the second optical surface S2 of the waveguide, leaves the waveguide in the +Z direction, and enters the center sensor 401A.

In summary, the multi-channel optical interference microscopic system provided by the embodiments of the disclosure is configured with the multiple waveguides corresponding to the multiple objective lenses, and different waveguides correspond to different objective lenses. Therefore, the light coming from different objective lenses may enter different waveguides without the crosstalk. In addition, since the light outlets of the different waveguides are spaced apart from each other, different sensors may be disposed outside the respective light outlets. Therefore, the phenomenon of insufficient field of view can be avoided, and the measurement accuracy of the system can be greatly increased.

What is claimed is:

1. A multi-channel optical interference microscopic system adapted to measure an object to be measured, wherein the multi-channel optical interference microscopic system comprises:
at least one light source configured to emit illumination light, wherein the illumination light is configured to illuminate the object to be measured and is reflected by the object to be measured into a light to be measured;
an objective lens array device comprising a plurality of objective lenses;
a plurality of waveguides receiving the light to be measured passed through the objective lens array device; and
a plurality of sensors comprising at least a first sensor and a second sensor,
wherein the plurality of waveguides comprise at least one first waveguide transmitting the light to be measured in a first direction and at least one second waveguide transmitting the light to be measured in a second direction, and the first direction is different from the second direction,
wherein the light to be measured outputted from the at least one first waveguide enters the first sensor, and the light to be measured outputted from the at least one second waveguide enters the second sensor.

2. The multi-channel optical interference microscopic system as claimed in claim 1, wherein each of the waveguides comprises a first optical surface, a second optical surface, and a beam splitter, the beam splitter is disposed on the first optical surface, and the beam splitter allows at least part of the illumination light to penetrate, and the at least part of the illumination light penetrating the beam splitter illuminates the object to be measured.

3. The multi-channel optical interference microscopic system as claimed in claim 2, wherein the beam splitter reflects the light to be measured.

4. The multi-channel optical interference microscopic system as claimed in claim 2, wherein the second optical surface reflects the light to be measured.

5. The multi-channel optical interference microscopic system as claimed in claim 1, wherein each of the objective lenses comprises a lens, a patterned optical element, and a beam splitting element sequentially stacked, a first portion of the illumination light sequentially penetrates the lens, the patterned optical element, and the beam splitting element, and then illuminates the object to be measured.

6. The multi-channel optical interference microscopic system as claimed in claim 5, wherein the patterned optical element comprises a transmission area and a reflection area, and the transmission area of the patterned optical element and the beam splitting element allow the first portion of the illumination light to penetrate.

7. The multi-channel optical interference microscopic system as claimed in claim 6, wherein the reflection area of the patterned optical element reflects a second portion of the illumination light.

8. The multi-channel optical interference microscopic system as claimed in claim 6, wherein the beam splitting element and the transmission area of the patterned optical element allow at least part of the light to be measured to penetrate.

9. The multi-channel optical interference microscopic system as claimed in claim 1, further comprising a moving mechanism adapted to move the object to be measured in a direction parallel to an optical axis of the plurality of objective lenses.

10. The multi-channel optical interference microscopic system as claimed in claim 1, wherein each of the waveguides is an etched surface waveguide.

11. The multi-channel optical interference microscopic system as claimed in claim 1, wherein a quantity of the plurality of objective lenses is equal to a quantity of the plurality of waveguides, and the light to be measured entering the plurality of waveguides comes from each of the plurality of objective lenses.

12. The multi-channel optical interference microscopic system as claimed in claim 1, wherein the plurality of objective lenses comprise at least one first objective lens, at least one second objective lens, and at least one center objective lens, the plurality of sensors further comprise a center sensor, the at least one first waveguide receives the light to be measured passed through the at least one first objective lens, the at least one second waveguide receives the light to be measured passed through the at least one second objective lens, and the light to be measured passed through the at least one center objective lens enters the center sensor.

13. The multi-channel optical interference microscopic system as claimed in claim 12, wherein a quantity of the at least one first objective lens is equal to a quantity of the at least one first waveguide, and a quantity of the at least one second objective lens is equal to a quantity of the at least one second waveguide.

14. The multi-channel optical interference microscopic system as claimed in claim 1, wherein a quantity of the at least one first waveguide is plural, and the light to be measured outputted from the plurality of first waveguides enters the first sensor.

15. The multi-channel optical interference microscopic system as claimed in claim 14, wherein a quantity of the at least one second waveguide is plural, and the light to be measured outputted from the plurality of second waveguides enters the second sensor.

16. The multi-channel optical interference microscopic system as claimed in claim 1, wherein the plurality of sensors further comprise a third sensor, the plurality of waveguides further comprise at least one third waveguide transmitting the light to be measured in a third direction, the third direction is different from the first direction and the second direction, and the light to be measured outputted from the at least one third waveguide enters the third sensor.
